(19) United States
(12) Patent Application Publication
(10) Pub. No.: US 2012/0000615 A1
(43) Pub. Date: Jan. 5, 2012

(54) Sunshade

(75) Inventor: Paul Lin, Yung-Kang City (TW)

(73) Assignee: Macauto Industrial Co., Ltd., Yung-Kang City (TW)

(21) Appl. No.: 12/889,546

(22) Filed: Sep. 24, 2010

(30) Foreign Application Priority Data
Jul. 5, 2010 (TW) 099122002

(51) Int. Cl. E06B 9/60

(52) U.S. Cl. 160/313

(57) ABSTRACT

A sunshade includes a hollow roller, a screen wound on the roller, and a torque unit. The roller has a plurality of positioning protrusions protruding inwardly therefrom. The torque unit includes an axle extending outwardly of the roller, an end plug and a stationary plug inserted fittingly in the roller, a spring, and a bushing. The end plug is sleeved rotatably on the axle. The stationary plug is sleeved fixedly on the axle. The spring is sleeved on the axle and has first and second end portions fixed respectively to the axle and the end plug. The roller, the end plug and the second end portion of the spring are rotated during operation of the screen, so that the spring is twisted and pitches of the spring are decreased. The bushing is disposed between the roller and the spring, is in frictional contact with the protrusions so as to be immovable relative to the roller, and is made of a plastic material.

### BACKGROUND OF THE INVENTION

1. Field of the Invention

The present invention relates to a sunshade, more particularly to a sunshade that can be operated noiselessly and that has a relatively long service life.

2. Description of the Related Art

Referring to FIGS. 1 and 2, a conventional sunshade 1 includes a roller 11 extending in an axial direction (L), a screen 14 wound on the roller 11, a torque unit 13, and a pin unit 12 spaced apart from the torque unit 13. The torque unit 13 includes an axle 131, an end plug 132, a stationary plug 133 spaced apart from the end plug 132 in the axial direction (X), a spring 134, and a bushing 136.

The spring 134 has a first end portion connected fixedly to the axle 131 adjacent to the stationary plug 133, and a second end portion connected fixedly to the end plug 132. The roller 11, the end plug 132 and the second end portion of the spring 134 are rotated during operation of the screen 14 from a wound state to an unwound state, so that the spring 134 is twisted and the pitches 135 of the spring 134 are decreased.

The roller 11 is usually made of metal. The bushing 136 is disposed between the roller 11 and the spring 134, and is generally made of fabric so as to prevent noise due to collision between the roller 11 and the spring 134 during operation of the screen 14 from the wound state to the unwound state. The bushing 126 is movable relative to the roller 11 in the axial direction (X) and is mounted between the roller 11 and the spring 134 so as to avoid generation of noises.

However, the bushing 136 has a tendency to deform to result in creases 137 that may be clamped between the pitches 135 of the spring 134 when the spring 134 is twisted. Once being clamped, the bushing 136 cannot return to its original shape even if the spring 134 is untwisted and the pitches 135 return to the normal state. Consequently, the bushing 136 will be intertwined with the spring 134 after long term use to result in damage to the conventional sunshade 1.

### SUMMARY OF THE INVENTION

Therefore, the object of the present invention is to provide a sunshade capable of alleviating the above drawbacks of the prior art.

Accordingly, a sunshade of this invention comprises a hollow roller, a screen, a latch unit, and a torque unit. The hollow roller extends in an axial direction and has first and second open ends that are opposite to each other in the axial direction, and a plurality of positioning protrusions that protrude inwardly from an inner surrounding surface thereof. The screen is wound on the roller and is operable to move from a wound state to an unwound state. The latch unit is disposed in the roller and extends outwardly of the first open end of the roller. The torque unit includes an axle, an end plug, a stationary plug, a spring, and a bushing. The axle extends in the roller along the axial direction and extends outwardly of the second open end of the roller. The end plug is inserted fittingly in and co-rotatably with the roller, and is sleeved rotatably on the axle adjacent to the second open end. The stationary plug is inserted fittingly in the roller is sleeved fixedly on the axle and is spaced apart from the end plug in the axial direction. The spring is disposed in the roller, is sleeved on the axle, and has a first end portion connected fixedly to the axle adjacent to the stationary plug, and a second end portion connected fixedly to the end plug. The roller, the end plug and the second end portion of the spring are rotated during operation of the screen from the wound state to the unwound state, so that the spring is twisted and pitches of the spring are decreased. The bushing is disposed between the roller and the spring and has an outer surface in frictional contact with the protrusions of the roller such that the bushing is immovable relative to the roller in the axial direction. The bushing is made of a plastic material so as to avoid deformation of thereof during the twisting of the spring.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary partly sectional view of a conventional sunshade;

FIG. 2 is an partly enlarged fragmentary partly sectional view of the conventional sunshade;

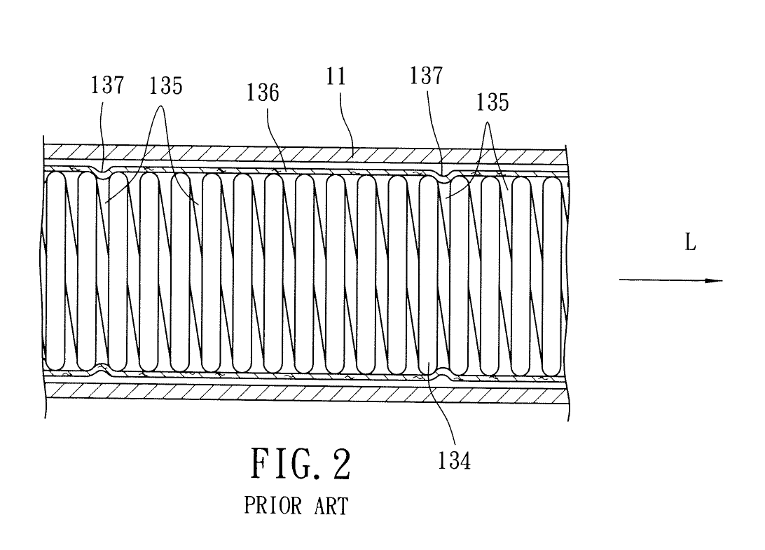

FIG. 3 is an exploded perspective view of a preferred embodiment of a sunshade according to the present invention;

FIG. 4 is a fragmentary partly sectional view of the preferred embodiment;

FIG. 5 is an enlarged fragmentary partly sectional view of the preferred embodiment, illustrating a spring of a normal state; and

FIG. 6 is a partly enlarged view similar to FIG. 5, but illustrating the spring at a twisted state.

### DETAILED DESCRIPTION OF THE PREFERRED EMBODIMENT

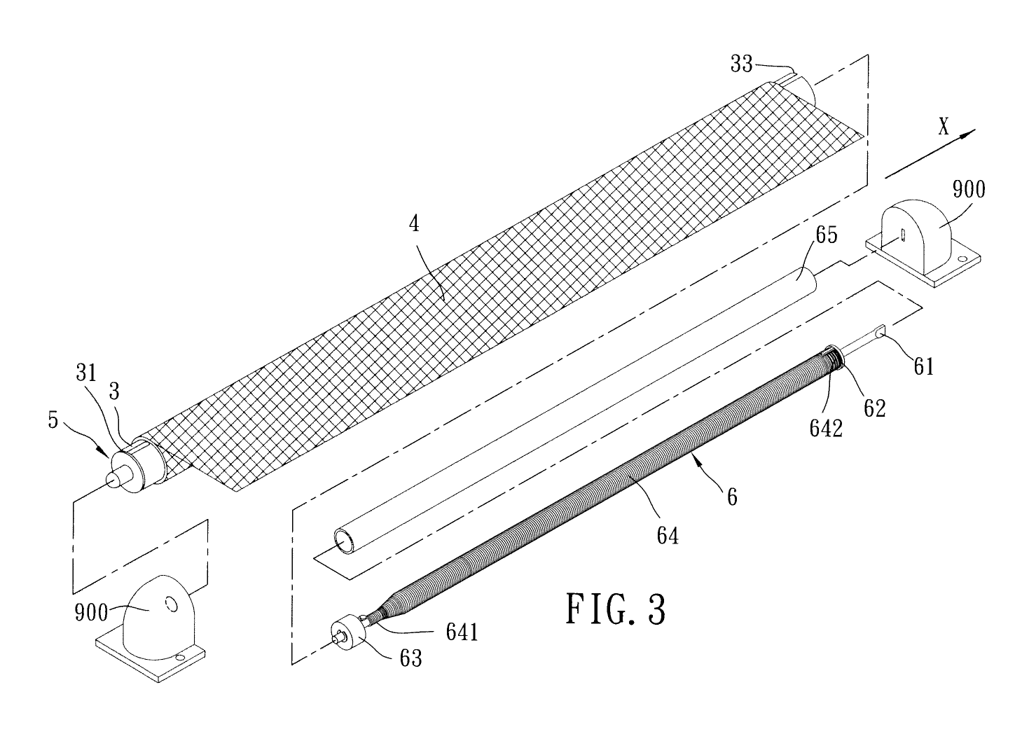

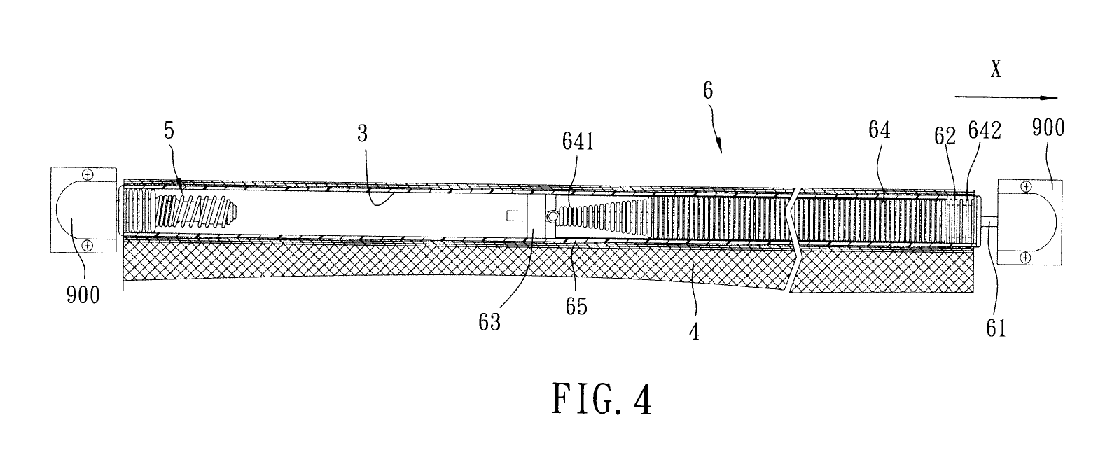

Referring to FIGS. 3 to 5, a preferred embodiment of a sunshade according to the present invention is shown. The sunshade comprises a hollow roller 3 extending in an axial direction (X), a screen 4, a latch unit 5, and a torque unit 6. The roller 3 has first and second open ends 31, 33 that are opposite to each other in the axial direction (X), and a plurality of positioning protrusions 32 protruding inwardly from an inner surrounding surface thereof, spaced apart from each other in the axial direction (X), and provided in a manner that each one is aligned diametrically with another one. In this embodiment, the roller 3 is made of aluminum alloy, and the positioning protrusions 32 are formed by stamping on an outer surrounding surface of the roller 3. However, the configuration and the manufacturing process of the positioning protrusions 32 are not limited to this embodiment.

The screen 4 is wound on the roller 3 and is operable to move from a wound state to an unwound state. The latch unit 5 is disposed in the roller 3, extends outwardly of the first open end 31 of the roller 3 and is adapted to be coupled to a mounting seat 900. The torque unit 6 is adapted to be coupled to a mounting seat 900, and includes an axle 61, an end plug 62, a stationary plug 63, a spring 64, and a bushing 65.

The axle 61 extends in the roller 3 along the axial direction (X) and extends outwardly of the second open end 33 of the roller 3. The end plug 62 is inserted fittingly in and co-rotatably with the roller 3, and is sleeved rotatably on the axle 61 adjacent to the second open end 33. The stationary plug 63 is inserted fittingly in the roller 3, is sleeved fixedly on the axle 61, and is spaced apart from the end plug 62 in the axial direction (X). The spring 64 is disposed in the roller 3, is sleeved on the axle 61, and has a first end portion 641 connected fixedly to the axle 61 adjacent to the stationary plug 63, and a second end portion 642 connected fixedly to the end plug 62. Since the feature of this invention does not reside in the axle 61, the end plug 62, and the spring 64, further details of the same are omitted herein for the sake of brevity.

In this embodiment, the bushing 65 is disposed between the roller 3 and the spring 4, is made of a plasticmaterial, such as polyvinyl chloride (PVC), and the positioning protrusions 32 of the roller 3 abut against an outer surface of the bushing 65, such that the bushing 65 is immovable relative to the roller 3 in the axial direction (X).

It should be noted that the positioning protrusions 32 are formed on the inner surrounding surface of the roller 3 after the torque unit 6 is mounted to the roller 3, but the forming procedure of the positioning protrusions 32 is not limited to this aspect in other embodiments of this invention.

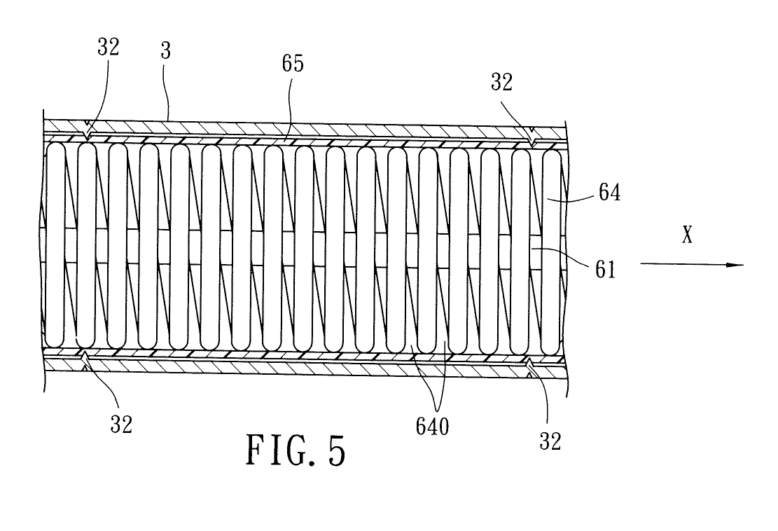

When the screen 4 is at the wound state, the bushing 65 is at a normal state and is sleeved fittingly on the spring 64 (see FIG. 5), such that collision between the spring 64 and the roller 3 can be avoided.

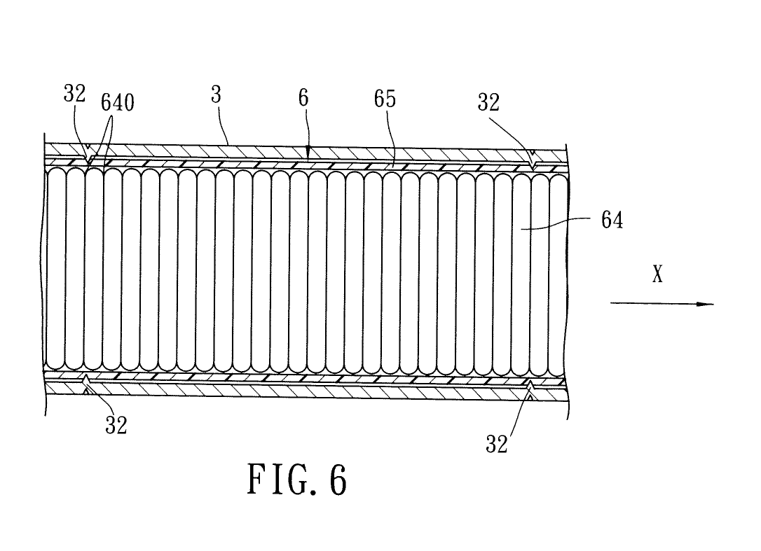

During operation of the screen 4 from the wound state to the unwound state, the roller 3, the end plug 62 and the second end portion 642 of the spring 64 are rotated, so that the spring 64 is twisted and pitches 640 of the spring 64 are decreased (see FIG. 6). As a result, a diameter of the spring 64 also decreases to be slightly smaller than that of the bushing 65. Due to the frictional engagement between the bushing 65 and the positioning protrusions 32 of the roller 3, the bushing 65 is still immovable relative to the roller 3 and the spring 64 in the axial direction (X). Furthermore, since the bushing 65 is made of a plastic material, deformation of the bushing 65 during the twisting of the spring 64 can be avoided.

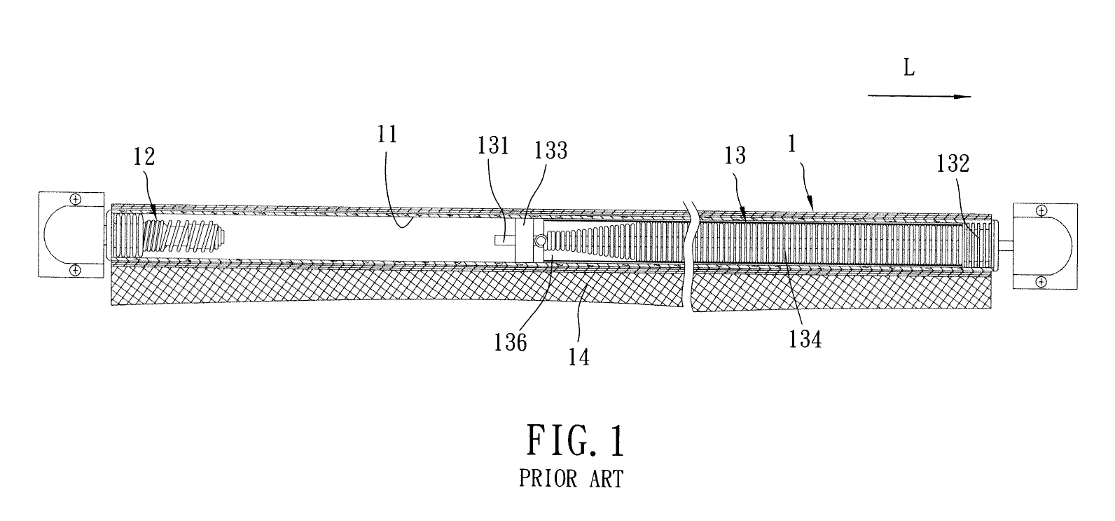

To sum up, the advantage of the sunshade according to the present invention is as follows. Compared to the conventional sunshade as illustrated in FIG. 1, the configuration of the positioning protrusions 32 of the roller 3 and the plastic-made bushing 65 keep the bushing 65 in place without deformation of the bushing 65 during use.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade comprising:
a hollow roller extending in an axial direction, and having first and second open ends that are opposite to each other in the axial direction, and a plurality of positioning protrusions that protrude inwardly from an inner surrounding surface thereof;
a screen wound on said roller, and operable to move from a wound state to an unwound state;
a latch unit disposed in said roller and extending outwardly of said first open end of said roller; and
a torque unit including
an axle that extends in said roller along the axial direction and that extends outwardly of said second open end of said roller,
an end plug that is inserted fittingly in and co-rotatably with said roller, and that is sleeved rotatably on said axle at a position adjacent to said second open end,
a stationary plug that is inserted fittingly in said roller, that is sleeved fixedly on said axle, and that is spaced apart from said end plug in the axial direction,
a spring that is disposed in said roller, that is sleeved on said axle, and that has a first end portion connected fixedly to said axle adjacent to said stationary plug, and a second end portion connected fixedly to said end plug,
said roller, said end plug and said second end portion of said spring being rotated during operation of said screen from the wound state to the unwound state, so that said spring is twisted and pitches of said spring are decreased, and
a bushing that is disposed between said roller and said spring, and that has an outer surface in frictional contact with said positioning protrusions of said roller such that said bushing is immovable relative to said roller in the axial direction, said bushing being made of a plastic material so as to avoid deformation thereof during the twisting of said spring.
